(19) United States
(12) Patent Application Publication
(10) Pub. No.: US 2007/0012183 A1
(43) Pub. Date: Jan. 18, 2007

(54) Method and apparatus for the continuous preparation of porous materials and mixed metal oxides using continuous stirred reactors

(75) Inventors: Sung-Hwa Jhung, Daejeon-city (KR); Jong-San Chang, Daejeon-city (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Research Institute of Chemical Technology, Daejeon-city (KR)

(21) Appl. No.: 11/485,803

(22) Filed: Jul. 13, 2006

(30) Foreign Application Priority Data
Jul. 18, 2005 (KR) 10-2005-0064629

(51) Int. Cl. B01D 53/22

(52) U.S. Cl. 95/54

(57) ABSTRACT

Disclosed is a method to prepare porous materials, which can not only be used for a catalyst, an adsorbent, a catalytic support, in ion exchange and gas storage, and the like, but can also be used to reserve or separate guest molecules with spaces (nanometer spaces) of nanometer size, and mixed metal oxides used as functional ceramics. More particularly, there is disclosed a preparation method, in which microwave energy is used as a heat source and a continuous stirred type reactor is used, the temperature is controlled by directly measuring the temperature of the slurry composed of the reactants, solvent and the product, and the pressure is controlled by measuring the pressure of the gas to thereby improve the stability of operation and the reproducibility, and it is easy to control the residence time and increase of the productivity, and the like can be accomplished. Further, according to the present invention, an apparatus to continuously prepare porous materials and mixed metal oxides for performing the preparing method is provided.

### BACKGROUND OF THE INVENTION

1. Field of the Invention

The invention relates to a method for preparing materials comprising porous materials and mixed metal oxides, and an apparatus for the same. More particularly to a method for preparing a material comprising porous materials and mixed metal oxides, using microwave energy as a heat source for hydrothermal or solvothermal synthesizing reaction instead of the conventional electric heating, and using a continuous stirred reactor as a reactor.

Also, the present invention relates to a method for preparing a material comprising porous materials and mixed metal oxides, which are characterized in that the continuous stirred reactor directly measures the temperature of the slurry composed of reactant and product; controls the pressure of gas in a reactor, and progresses the reaction by performing automatic draining of reactant and product when the level of the reactant and the product becomes to be above set value.

Further, according to the present invention, if it is required to increase residence time in the reactor and if the reactants, which are not reacted, are remained because the residence time is distributed broadly to result in a broad distribution of the reaction conversion, it is possible to connect at least two reactors in series and operate them.

In addition, the invention relates to a method for preparing materials comprising porous materials and mixed metal oxides, and an apparatus for the same, and more particularly, to an apparatus for preparing a material for preparing materials comprising porous materials and mixed metal oxides, which uses microwave energy as a heat source for hydrothermal or solvothermal synthesizing reaction instead of the conventional electric heating, and uses a continuous stirred reactor as a reactor.

2. Background of the Related Art

A porous material is a material, comprising silicon (Si), aluminum (Al), phosphorus (P), and oxygen (O), and in particular the porous material represents a material having a pore size below 50 nm (Nature, vol. 417, p. 813 (2002), Pure and Applied Chem. Vol. 31, p. 578 (1972). A metal can be included as a constituting component for porous materials, and recently, an organic-inorganic hybrid material comprising an organic material and an inorganic material concurrently is classified as porous materials (Angew. Chem. Intl. Ed, vol. 43, p. 2334 (2004); Chem. Soc. Rev., vol. 32, p. 276 (2003); Microporous Mesoporous Mater., vol. 73, p. 15 (2004)). Such materials have components as a transition metal and a lanthanum (La), in addition to silicon, aluminum, and phosphorus, holding an oxygen or an organic material in common, thereby being connected in a three dimensional structure, and has pores of a special size and shape according to the synthesizing condition (Chem. Review vol. 99, p. 635, 1999; U.S. Pat. No. 4,567,029). Such porous materials are prepared by using water or an organic material as a solvent, in general, by means of the hydrothermal or solvothermal method, in which reaction is performed at high temperature (50 to 300 ° C. in general).

The porous material employs water or a proper organic material as a solvent and is synthesized principally under autogenous pressure produced due to high temperature. While the mixed metal oxides, including a perovskite, can be prepared through several processes, they can be obtained by maintaining at high temperature under the presence of the solvent.

Until now, an electric heating was employed, in general, as a heat source for obtaining high temperature for preparing porous materials and mixed metal oxides. In other words, the reaction was performed by heating a reactor by using an electric furnace after charging the reactants into the pressure reactor and closed it tightly, or by charging the pressure reactor, into which reactants are received, into an electric oven, which can be controlled to a proper temperature. In case of such synthesis, because it required at least a few days of reaction time at high temperature in general, excessive energy was required and the reaction progressed only in a batch-mode, resulting in low productivity.

Also, a technology to prepare porous materials by using microwaves as the heat source (U.S. Pat. No. 4,778,666; Catalysis Survey Asia vol. 8, p. 91, 2004) has been partially known since 1988. In many cases like synthesizing other materials, it was possible to reduce the reaction time by controlling the reaction conditions in the synthesis of porous materials and mixed metal oxides by using the microwave energy. However, the synthesis of the porous materials and the mixed metal oxides has been performed in a batch-mode. The technology of a stable synthesis to continuously synthesize a material comprising porous materials and mixed metal oxides is a requisite technology to increase productivity, automation, and economical efficiency, however, it is not known.

Further, after the report of the example performing continuous hydrothermal reaction by controlling the speed of the nuclear formation and the grain growth (Zeolites, vol. 15, p. 353, 1995), the technology to continuously prepare porous materials by electric heating has not been developed because the reaction time was too long. Then, methods of synthesis by using microwaves have been attempted and reported a few times, however, they have principally employed reactors having a shape of a very long coil or used in low temperature within 100□. For instance, AlPO-5 synthesis, applying a tube type coil reactor, (Microporous Mesoporous Materials vol. 23, p. 79, 1998) and results of synthesizing a several porous materials and inorganic materials have been known (Korea patent registration No. 10-0411194, Japan patent registration No. 3526837). However, using very long coil reactors, caused problems: pressure difference can be produced seriously in the reactor; the control of the temperature and pressure is not easy, thereby caused explosion of the reactors; and the serious change of the reaction pressure and temperature of the reactor, and the like. Meanwhile, there was an example that reactants were transported by means of a conveyor and reaction was progressed with radiating the microwaves on the reactants (U.S. Pat. No. 6,663,845B1). However, in this case, the temperature of reaction was to be very low because it was impossible to avoid vaporization of the solvent above the boiling point of the solvent. The present applicant developed and filed a technology to continuously prepare porous materials and mixed metal oxides by using a tube type reactor, having no connection portion, and using microwave energy as a heat source (Korea patent application No. 10-2005-0063442). However, several problems were produced: the construction of the reactor was complex, and it was substantially difficult to operate the apparatus stably for a long time because clogging of the reactor and serious change of the temperature and pressure were occurred due to the use of the tube type reactor. A continuous stirred type reactor has been used as a reactor in several chemical processes, however it has not been used in the reaction using the microwaves as the heat source.

In the present invention, the microwave energy has been used as the heat source and the continuous stirred type reactor has been used to synthesize porous materials and mixed metal oxides. The present invention was completed by measuring the temperature in the portion where the reactant and product is equally stirred; controlling the reaction temperature by adjusting the radiation of microwaves from magnetron; controlling the pressure using a pressure controller by measuring the pressure of gas phase, passed through a cooler; and setting the continuous stirred reactor to automatically drain reactant and product when the level of the reactant and product become more than the set value. The above composition of the continuous stirred reactor was advantageous in that the operation and reproducibility became higher in preparing porous materials and the mixed metal oxides; the adjustment of residence time became more easy; and the increase in production and the like.

The applicability of the porous materials is very broad because it can be used as a catalyst, a catalytic support, an adsorbent, in ion exchange and storage of the gas, and as well as it can be used in storage, preparation, and separation of nanometer-materials, and it can be used as nanometer reactors. Also, the use of mixed metal oxides, including a perovskite, has been progressively enlarged: it is used as an electronic ceramic material, and the like. Accordingly, it has been very strongly required to develop a technology to prepare porous materials and mixed metal oxides with a short time reaction, more preferably continuously.

### SUMMARY OF THE INVENTION

Therefore, the present invention has been accomplished in view of the above problems occurring in the prior art, and it is an object of the present invention to provide a continuous preparation technology of a material comprising porous materials and mixed metal oxides, which is stable in the preparing process, easy to control the temperature and pressure, and to develop a reacting apparatus for making such synthesis possible.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view for showing a construction of a continuous stirred type reactor to continuously prepare porous materials and mixed metal oxides by using microwaves energy;

FIG. 2 is a view for showing x-ray diffraction patterns of materials having an AEL structure, in which (a), (b), (c) and (d) correspond respectively to an x-ray diffraction pattern of a material obtained by the result of the example 1, the example 2, the comparative example 1, and the comparative example 2;

FIG. 3 is a view for showing an x-ray diffraction pattern of a nickel-phosphate having a VSB-1 structure, in which (a) and (b) correspond respectively to an x-ray diffraction pattern of a material obtained by the result of example 5 and example 6;

FIG. 4 is a view of an x-ray diffraction pattern of a nickel-phosphate having a VSB-5 structure, in which (a) and (b) correspond respectively to an x-ray diffraction pattern of a material obtained by the result of example 7 and comparative example 3;

FIG. 5 is a view of an x-ray diffraction pattern of a nickel-glutarate having a MIL-77 structure, which corresponds to an x-ray diffraction pattern of a material obtained from the result of example 8.

### DETAILED DESCRIPTION OF THE PREFERRED EMBODIMENT

The present invention has been intended to develop an effective method for preparing a material comprising porous materials and mixed metal oxides, and a continuous preparation apparatus for the same, and is characterized by continuously preparing a material comprising porous materials and mixed metal oxides by using microwave energy as a heat source for the reaction. Hereinafter, the present invention will be described in detail as follows.

The porous material can comprise a metal component as an extra element in addition to silicon, aluminum, and phosphorus. The silicon, aluminum, and phosphorus, which are principal constituting elements of porous material, can be formed in any precursors. However, in view of convenience and cost, silica, fumed silica, silica sol, water glass, tetra-ethyl-ortho-silicate (TEOS), tetra-methyl-ortho-silicate (TMOS), sodium silicate, alumina, sodium aluminate, alumino-silicate, aluminum alcoxide, and phosphoric acid are proper. The alumina can be of any structure, and pseudoboehmite and boehmite are proper. As for phosphoric acid, a phosphoric acid having a purity of 85 wt % is most proper. As for the metal component, the metal itself can be used, a transition metal, a main group element, and lanthanum (La) can be used. Among the transition metals, titanium, vanadium, chromium, manganese, iron, cobalt, nickel, copper, zinc, and the like can be properly used. Among the main group elements, boron and gallium are proper, and among the lanthanum (La) group metals, cerium and lanthanum are proper. As for the metal component, any metal complex including the metal itself can be properly used. Especially, nitrate, chloride, acetate, sulfate, carbonate, oxides, and hydrates can be used properly. In addition to the metallic component, the elements for connecting a metal with another metal or positioned between the metals are oxygen, sulfur, and the like in principal, and an organic material called a linker can be used.

As for the linker, any organic material, which is provided with a position for coordination, such as —CO₂—, —CS₂—, —SO₃—, and —N— can be used. In order to induce stable organic-inorganic hybrid, it is preferable for an organic material (such as bidentate, tridentate, and the like) to have at least two coordination sites. As for an organic material, if there is any site for coordination, neutral materials (such as bipyridine, pyrazine, and the like), negative ion material (negative ion of the carboxylic acid, and the like such as terephthalate, glutarate, and the like), and anion material can be used. As for the negative ion of the carboxylic acid, any of those selected from negative ions having an aromatic ring such as terephthalate, negative ions of linear carboxylic acid such as formate, and negative ions having a non-aromatic ring such as cyclo-hexyl-dicarbonate can be used. Not only organic material having sites for coordination, but also materials having potential coordination site, so that it can be transformed into coordination site at any reaction condition, can be used. In other words, when organic acid, such as terephthalic acid, is used, it can be transformed into the terephthalate during the reaction to thereby be able to combine with the metallic component. As for the usable representative examples, organic acid such as benzene-dicarboxyl acid, naphthalene-dicarboxyl acid, bezene-tricarboxyl acid, naphthalene tricarboxyl acid, pyredine dicarboxyl acid, bipyridyl-dicarboxyl acid, formic acid, oxalic acid, malonic acid, succinic acid, glutaric acid, hexandioic acid, heptandioic acid, and negative ion thereof, pyrazine, bipyridine, and the like can be used. Also, two or more organic materials can be mixed and used.

In the synthesis of any of the porous material, organic material containing nitrogen in principal, such as a template, is required to obtain porosity. It acts as a mold for the porous material, and amine or ammonium salt is proper for it in principal. As for the amine, monoamine, diamine, triamine, and the like can be used. As for the monoamine, tertiary amine such as tri-ethyl-amine, tri-prophyl-amine, di-iso-prophyl-amine, tri-ethanolamine, secondary amine such as di-butyl-amine, di-prophyl-amine, and the like, and primary amine such as heptyl-amine, octyl-amine, nonyl-amine, and the like, and amine having a ring shaped structure such as morpholine, cyclohexyl-amine, pyridine, and the like can be used. As for the diamine, diaminoethane, diaminopropane, diaminobutane, diaminoheptane, diaminohexane, and the like can be used, however, the diamine is not limited to them. As for the ammonium salt, tetra-methyl-ammonium-hydroxide, tetra-ethyl-ammonium-hydroxide, tetra-propyl-ammonium-hydroxide, tetra-butyl-ammonium-hydroxide, tetra-methyl-ammonium-chloride, tetra-ethyl-ammonium-chloride, tetra-propyl-ammonium-chloride, tetra-butyl-ammonium-chloride, tetra-methyl-ammonium-bromide, tetra-ethyl-ammonium-bromide, tetra-propyl-ammonium-bromide, tetra-butyl-ammonium-bromide, tetra-methyl-ammonium-fluoride, tetra-ethyl-ammonium-fluoride, tetra-propyl-ammonium-fluoride, tetra-butyl-ammonium-fluoride, and the like can be used. Proper solvent is required in addition to silicon, aluminum, phosphorus, metal component, and oxygen or a linker material, template in the synthesis of the porous materials, and in this regard, any material such as water, alcohol (methanol, ethanol, propanol, and the like), ketone (acetone, methyl-ethyl-ketone, and the like), hydrocarbon (hexane, heptane, octane, and the like), and the like can be used, and two or more solvent can be mixed and used, and water is most appropriate.

As for the porous material, to be synthesized, could have any composition and structure, such as microporous materials, mesoporous materials, organic-inorganic hybrids, and the like. However, what is especially subjected in the present invention is such porous materials as phosphate molecular sieves including AEL, CHA, AFI (Atlas of Zeolite Structure Types, Elsevier, London, p. 20, p. 76 and p. 26, 1996), and the like, zeolite such as LTA, FAU, MFI (Atlas of Zeolite Structure Types, London, p. 130, p. 104, and p. 146, 1996), a mesoporous material including SBA, a nickel-phosphate microporous body including VSB-1 (C. R. Acad. Sci. Paris vol. 2, p. 387, 1999), VSB-5 (Angew. Chem. Intl. Ed. Vol. 40, p. 2831, 2001), and organic-inorganic hybrid including MIL-77 (Angew. Chem. Intl. Ed. Vol. 42, p. 5314, 2003).

The AEL structure is a structure of constructing the pore by ten oxygens (they are existed between the metal, aluminum, or phosphorus), includes SAPO-11, AlPO-11, and the like, and can be used as a catalyst for the cracking. The CHA structure is a structure wherein a relatively small pore is constructed of eight oxygens (they are existed between the metal, aluminum, or phosphorus), and includes SAPO-34, CoAPO-34, MnAPO-34, and the like, and is used as a commercial catalyst in a process of preparing olefin from the methanol. The AFI structure is a structure wherein a pore is constructed of twelve oxygens (they are existed between the metal, aluminum, or phosphorus), and includes AlPO-5, SAPO-5, VAPO-5, CoAPO-5, and FAPO-5, and the like, and can be used to prepare several materials of nanometer structure (Nature, vol. 408, p. 50, 2000) . The LTA structure has a relatively small pore constructed of eight oxygens and constituting a frame, in which silicon and aluminum own the oxygen in common, and is used in principal as a builder for a detergent and an adsorbent. The FAU structure has a relatively big pore constructed of twelve oxygens and constituting the frame, and in which the silicon and the aluminum own the oxygen in common, and is used as an adsorbent and a catalyst for the petrochemicals. The MFI structure has a pore constructed of ten oxygens (they are existed between the metal, aluminum, or phosphorus), and includes ZSM-5, silicalite-1, TS-1, and the like, and is used diversely as a catalyst and a separating agent for several chemical processes.

The SBA-16 structure is non-amorphous type SiO₂ having an Im3m space group constructed of a three dimensional network of Si—O—Si (J. Am. Chem. Soc. Vol. 120, p.6024-6036, 1998). Differently from the Zeolite, it uses a surfactant as for the structure-directing agent. In this regard, a polymer such as Pluronic F127, F108, and P123, and the like is used representatively. The SBA-16 has a very high surface area of 400˜1000 m²/g. The SBA-16 has a cake-like structure in which the size of inlet is big above 4 nm, and the size of the pore is 10 nm, in comparison with the mesoporous material in the MCM group. Further, wall thickness is 4-10 nm and thermal stability thereof has been improved so that it has been used as a catalyst as well as a media to prepare functional carbonic material. Also, it has been applied to sensor materials for detecting gaseous complex, and for accommodation and separation of biochemical molecules in recent years. The MIL-77 is an organic-inorganic hybrid composed of nickel and glutaric acid, and is a microporous material, which has a big applicability such as a chiral structure and special magnetic property, and the like.

The perovskite, which is one of the mixed metal oxides, is an inorganic material having a composition of ABO₃, wherein the A has an octahedral coordination and B has a dodecahedral coordination. In this regard, BaTiO₃, SrTiO₃, PbZrO₃, BaZrO₃, LaAlO₃, KNbO₃, and the like can be exemplified for such materials and is used for electronic ceramics. The mixed metal oxides can be prepared through several processes, and can be prepared through hydrothermal synthesizing method, in which a material is maintained at high temperature with a solvent. In recent, the BaTiO₃, which can be used in a multi-layer ceramic condenser, and the like, is prepared in principal through the hydrothermal method instead of the high temperature calcining process. As for the source for barium, any material can be used, however, barium chloride, barium fluoride, barium nitride, barium hydroxide, and the like can be easily used. As for the source for titanium, any material can be used, however, titanium chloride, titanium chloride, titanium nitride, titanium hydroxide, and the like can be easily used. As for the mineralizer, any chemical base can be used as far as it is a strong base: sodium hydrate or potassium hydrate can be easily used.

The present invention is characterized by using the microwaves instead of the general electric heating for the heat source of high temperature reaction. In this regard, any microwave having a frequency ranging from 1000 MHz to 30 GHz can be used to heat the reactants, however, it is simple and efficient to use the microwaves having a frequency of 2.45, and 0.915 GHz, and the like.

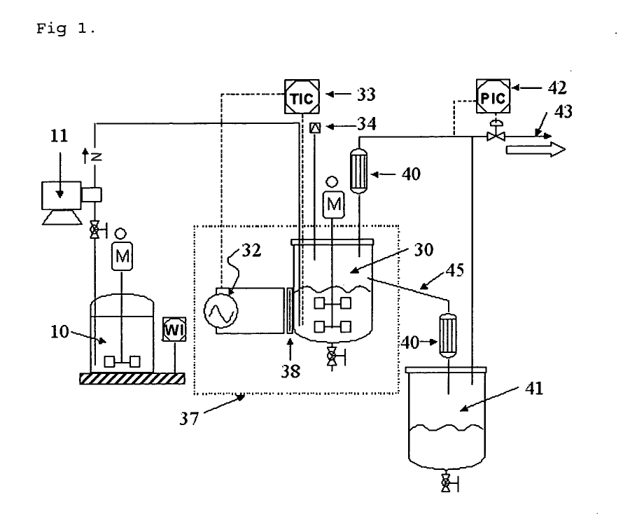

Hereinafter, the continuous reaction apparatus of the preset invention will be described with reference to the appended FIG. 1. The concept of the continuous reaction apparatus of the present invention has been shown in FIG. 1. As shown in FIG. 1, the apparatus of the present invention comprises a reactant drum 10, a slurry pump 11, a continuous stirred type reactor 30, a magnetron 32 for producing the microwaves, a temperature measuring and controlling unit 33, a cooler 40, a product drum 41, and a pressure measuring and controlling unit 42, and further comprises an outlet 43 for discharging the gaseous material supplied or vaporized from the continuous stirred type reactor 30, and a drain line 45 for discharging the product when the level of the reactants in the continuous stirred type reactor 30 is above the predetermined level.

Further, a shielding curtain 37 for shielding the microwaves produced from the continuous stirred type reactor 30 and the magnetron 32, a sight glass 38 mounted between the magnetron 32 and the continuous stirred type reactor 30, and a cooler 40 for cooling the product discharged from the drain line 45.

Hereinafter, respective constitution of the continuous stirred type reaction apparatus of the present invention will be described in detail below.

The reactant materials can be metered and stirred in the reactant drum 10, and the reactants in the drum 10 can be continuously supplied to the continuous stirred type reactor 30 by using the slurry pump 11. The continuous stirred type reactor 30 is made of stainless steel, titanium, Hastelloy, and the like. The thick sight glass 38 made of glass, quartz, ceramic, and the like, through which the microwaves can penetrate, is mounted on a wall surface of the continuous stirred type reactor 30 to radiate the microwaves. The number of the sight glass and the number of the magnetron producing the microwaves can be increased according to the increase of the volume of the reactor. In other words, at least two magnetrons 32 can be mounted, and they can be preferably mounted at 180, 120, 90 degrees, and the like respectively. The drain line 45 is connected to a position of predetermined height in the side surface of the continuous stirred type reactor 30 so that the liquid and the solid can be automatically discharged when the level of them in the reactor is increased to the set value. The gaseous component passes through the pressure measuring and controlling unit 42 via the cooler 40 mounted above the reactor so that it can be automatically discharged when the pressure thereof becomes to be above the set value.

A plurality of reactors can be connected in series to increase the residence time or to reduce the component, which has not been reacted due to the broad distribution of the residence time, which is the feature of the continuous stirred type reactor. It is preferable to make the reactants flow downward when several reactors are connected. When the reaction is completed, material comprised of the reactants, intermediate product, and the final product is cooled to collect the solid and the liquid in the product drum 41, and the gases are discharged through the outlet 43 by means of the pressure measuring and controlling unit 42. It is more preferable to arrange a separation tank (not shown separately) for separating the solid from the liquid instead of the product drum 41 so that they can be dried and packaged following the removal of the liquid, if it is necessary to produce the product more massively. According to the pressure measuring and controlling unit 42, it is possible to measure the pressure of the gas accurately without the hindrance of the solid and the liquid, and it is possible to control the pressure indicating the pressure of the reactor very stably.

Although the pressure of the reactor is not substantially limited, it is preferable to be within 500 psi, and it is simple to synthesize the product at the autogenous pressure of the reactants. Further, it is possible to start the reaction at high pressure after adding a solvent to the reactor at the start of the reaction, and also it is possible to continuously supply the reactants after filling the reactor with the reactants and operating it for some time in batch type. However, it is preferable to increase the pressure of the reactor by filling the reactor with the reactants before continuously supplying the reactants because it is possible to prevent the vaporization of the solvent to make the stable operation.

The temperature of the reaction is not substantially limited, however, it is preferable to be above 50° C., and more preferable to be above 100° C. and below 250° C. If the temperature is too low, it will become ineffective because the reaction rate is low, and if the reaction temperature is too high, it is easy to obtain material without any pore, and it is easy for the impurities to be entrained because the reaction rate is too fast. Also, it becomes difficult to construct the reactor and becomes uneconomic because the inside pressure of the reactor becomes high.

The proper residence time in a reactor would be one minute to two hours. If the residence time is too long, the productivity becomes low, and if the residence time is too short, the reaction conversion is low. The residence time in every reactor is more preferable if it is one minute to thirty minutes.

The volume of the continuous stirred type reactor is preferable to be 200˜10000 cm³ per a magnetron 32 (microwave generator). In this regard, if it is too small, a plurality of reactors are required to thereby make it ineffective, and if it is too large, the advantage of the microwaves can be counterbalanced to reduce the efficiency of the reaction.

It is preferable to stir and mix the reactants sufficiently before the reaction because the reaction can be occurred at very high speed by means of the microwave. Especially, it is preferable to preheat the reactants at the temperature between the room temperature and the reaction temperature.

Hereinafter, the present invention will be described in more detail in connection with the unrestricted embodiments.

### EXAMPLE

### Example 1 (SAPO-11)

1) Preparation apparatus: the apparatus shown in FIG. 1 has been used to prepare a material comprising porous materials and mixed metal oxides. The reactants can be metered into mixtures in the reactant drum 10, and the mixtures can be transported to the continuous stirred type reactor 30 in which the microwave is radiated, the cooler 40, and the product drum 41 by using the slurry pump 11. Also, a thermostat was mounted to measure the temperature of the mixture of the reactant and the product in the continuous stirred type reactor 30. The temperature of reaction can be controlled, by adjusting the electric power of the magnetron, and the rupture 34 was mounted to prevent the rapid increase of the pressure by discharging the pressure automatically to thereby protect the increase of the pressure and the explosion of the reactor. The sight glass 38 made of glass was mounted to radiate the microwaves in the continuous stirred type reactor 30, and the mesh 37 made of stainless steel was mounted around the reactor to shield the microwaves to be leaked. The product drum 41 can collect the product, raw materials which were not reacted, intermediate material, the solvent, and the like drained from the continuous stirred type reactor 30 and can control the pressure of the reactor by measuring the pressure of the gas passed through the cooler 40, and pressure above the set pressure level can be discharged to the outside by means of the pressure controller 42.

It is possible to add a solvent before the beginning of the reaction and start the reaction at high pressure or to fill the reactor with the reactants and operate for some time in batch type and supply the reactants continuously to progress the reaction stably and smoothly. In this regard, due to such operations, it is possible to prevent the rapid evaporation of the solvent to thereby operate the reactor stably.

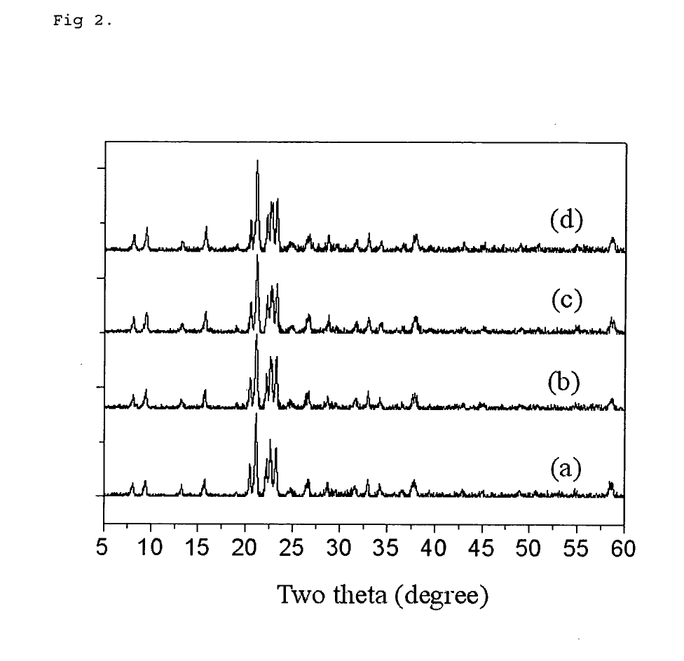

2) Preparation experiment: Distilled water was added to the phosphoric acid (85 wt %) to make the concentration of the phosphoric acid to be 42.5%, pseudobohemite was added, and silica sol (aqueous solution of 40 wt %), di-n-prophylamine (DPA), and remaining distilled water were added and then stirred effectively to form the composition of Al₂O₃:1.0P₂O₅:0.2SiO₂:1.5DPA:100H₂O, to thereby prepare the uniform reactant gel. After filling the continuous stirred type reactor 30 of the reaction apparatus shown in FIG. 1 and maintaining it at 180° C., and continuously supplying the reactants gel to the reaction apparatus by the pumping. The temperature of the mixture of the reactants and the product in the continuous stirred type reactor 30 is made to be 180° C. by controlling the electric power of the microwave oven, and the gas was discharged if the pressure level of the reactor was above 145 psi. The residence time in the continuous stirred type reactor 30 was 5 minutes, the product was collected in the reactant drum after ten minutes from the start of the reaction, and the product was cooled and separated into the solid and the liquid. From the x-ray diffraction pattern (confer FIG. 2a) of the product after the dry of the obtained product, it was possible to know that SAPO-11 of the AEL structure was obtained. The BET surface area measured after the calcining of the dried test piece at 550° C. for 10 hours was 300m²/g, and detailed condition of the experiment and the property of the obtained material are summarized in table 1. Comparing with comparative example 1 using the batch type reactor, it was possible to know that property of the porous materials obtained from the continuous synthesis was similar to that of the porous materials obtained from the batch type reactor. Further, comparing with comparative example 2 using the batch type reactor employing the general electric oven, it was possible to know that the synthesis speed was very high and the productivity thereof was very high in comparison with the electric oven.

### Example 2 (AlPO-11)

Reaction was performed similarly to example 1, however, reactant without the silicon component was used as the raw material. In other words, composition of the reactant was made to be Al₂O₃:1.0P₂O₅:1.5DPA:100H₂O, and it was possible to know that AlPO-11 was obtained from the x-ray diffraction pattern (confer FIG. 2b). Detailed condition of the experiment and property of the obtained material are summarized in table 1.

Comparative Example 1 (SAPO-11)

Experiment has been performed similarly to example 1, however, the batch microwave reactor was used instead of the continuous reactor. In other words, the SAPO-11 porous material was synthesized by charging the reactant of 40 g into the Teflon reactor and closed tightly, and mounting it to the microwave reactor (Mars-5, CEM corporation), and then the temperature of the reactor being increased to 180° C. and maintained for five minutes. From the x-ray diffraction pattern (confer FIG. 2c), it was possible to know that SAPO-11 was obtained. Detailed condition of the experiment and the property of the material are summarized in table 1.

### Comparative Example 2 (SAPO-11)

Synthesis has been performed similarly to comparative example 1, however, conventional electric oven was used instead of the microwave as the heat source, and the batch type reactor was used instead of the continuous reactor. The SAPO-11 porous material was synthesized by maintaining the reactants at 180° C. for five hours. From the x-ray diffraction pattern (confer FIG. 2d), it was possible to know that SAPO-11 was obtained. Detailed condition of the experiment and the property of the material are summarized in table 1.

### Example 3 (AlPO-5)

Reaction was performed similarly to example 1, however, reactant without the silicon component was used as raw material, and the triethylamine (TEA) was used as the template. That is, the composition of the reactant was made to be Al₂O₃:1.05P₂O₅:1.2TEA:100H₂O, and the residence time in the reactor was maintained to be twenty minutes. It was possible to know that AlPO-5 was obtained from the x-ray diffraction pattern. Detailed condition of the experiment and property of the obtained material are summarized in table 1.

### Example 4 (SAPO-34)

While the reaction was performed similarly to example 1, N,N-dimethyl-1,3-propanediamine(DMPDA) was used as the template, the respective residence time in the reactor was five minutes, and the pressure of reaction was maintained to be within 163 psi. In other words, the composition of the reactant was made to be Al₂O₃:1.0P₂O₅:0.1SiO₂:1.0HF:1.0DMPDA:100H₂O. From the x-ray diffraction pattern of the product, it was possible to know that SAPO-34 was obtained. Detailed condition of the experiment and the property of the obtained material are summarized in table 1.

### Example 5 (VSB-1)

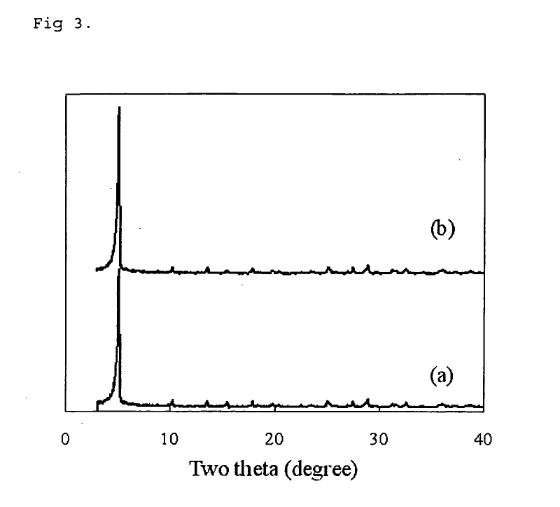

Reaction was performed similarly to the example 1, however, nickel-phosphate composed of nickel, phosphorus, and oxygen as frames was prepared. Nickel-chloride hexahydrate, phosphoric acid, ammonium fluoride, and distilled water were used as raw material, and the composition of the reactants was made to be NiCl₂:0.5P₂O₅:2.5NH₄F:100H₂O. The residence time in the respective reactor was ten minutes. From the x-ray diffraction pattern (confer FIG. 3a) of the product, it was possible to know that nickel-phosphate VSB-1 structure was obtained. Detailed condition of the experiment and the property of the obtained material are summarized in table 1.

### Example 6 (Fe—VSB-1)

Reaction was performed similarly to the example 5, however, nickel-phosphate containing iron was prepared, and the composition of the reactant was made to be NiCl₂:0.5P₂O₅:0.233FeCl₂:2.5NH₄F:100H₂O. The residence time in the respective reactor was ten minutes. From the x-ray diffraction pattern (confer FIG. 3b) of the obtained product, it was possible to know that nickel-phosphate Fe—VSB-1 structure containing iron was obtained. Detailed condition of the experiment and the property of the obtained material are summarized in table 1.

### Example 7 (VSB-5)

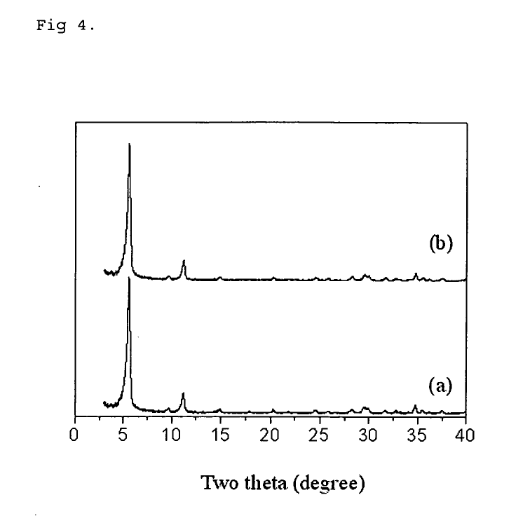

Experiment has been performed similarly to example 5, and it was performed at alkaline condition without fluorine component, and the composition of the reactant was made to be NiCl₂:0.315P₂O₅:3NH₃:100H₂O. The residence time was three minutes, and it was possible to know that nickel-phosphate VSB-5 was obtained from the x-ray diffraction pattern (confer FIG. 4a). Comparing with the comparative example 3, the property of the porous materials obtained from the continuous synthesis was similar to that of the porous materials obtained from the batch type reactor, and the productivity thereof was very high. Detailed condition of the experiment and the property of the material were summarized in table 1. According to table 1, it was possible to know that the reaction apparatus using the continuous stirred type reactor of the present invention provided product having identical property with that of the batch type reaction apparatus, and very high productivity, because VSB-5 having identical property with that of comparative example 3 using the batch type reactor.

### Comparative Example 3 (VSB-5 Batch)

Experiment has been performed similarly to example 7, however, the batch microwave reactor was used instead of the continuous reactor. In other words, the VSB-5 porous material was synthesized by charging the reactant of 40 g into the Teflon reactor and closed tightly, and mounting it to the microwave reactor (Mars-5, CEM corporation), and then the temperature of the reactor being increased to 180° C. and maintained for three minutes, resulting in the synthesis of the nickel-phosphate VSB-5 porous materials. From the x-ray diffraction pattern (confer FIG. 4b), it was possible to know that VSB-5 was obtained. Detailed condition of the experiment and the property of the material are summarized in table 1.

### Example 8 (MIL-77)

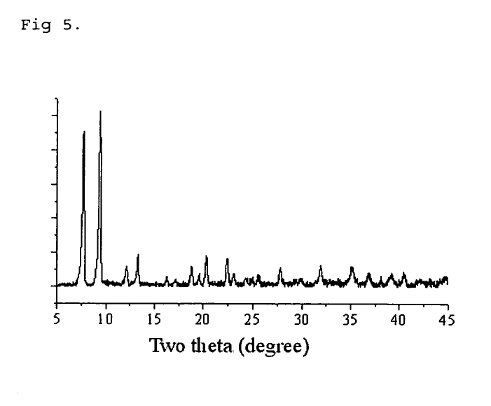

Reaction was performed similarly to example 1 to thereby prepare the organic-inorganic hybrid. As for the reactants, nickel-chloride hexahydrate, glutaric acid, iso-propyl acid (IPA), potassium chloride, and distilled water were used. The composition of the reactants was made to be NiCl₂:1.5GTA:1.0KOH:9.0IPA:30H₂O. The residence time in the respective reactor at 180° C. was maintained to be 5 minutes. From the x-ray diffraction pattern (confer FIG. 5) of the obtained product, it was possible to know that the MIL-77 structure of the organic-inorganic hybrid was obtained. Detailed condition of the experiment and the property of the obtained material are summarized in table 1.

### Example 9 (ZSM-5)

Reaction was performed similarly to example 1 to prepare the zeolite ZSM-5. As the reaction rate was slow, seed was first prepared, and reaction was performed with adding the seed to the reactants. In the preparation of the seed, tetra-ethylorthosilicate, tetrapropylammoniumhydroxide (TPAOH), and distilled water were used to make the reactants gel having the composition of SiO₂:0.2TPAOH:2OH₂O. The gel contains the ethanol due to the hydrolysis of the tetraethylorthosilicate. In this regard, the gel was maintained at 80° C. for one hour to remove the ethanol. Then, the gel for the seed was reacted at 165° C. for ten minutes by using the microwave reaction apparatus used in comparative example 1 to thereby obtain the seed. The seed for obtaining the zeolite ZSM-5 was of a spherical shape below about 100 nm when it was analyzed after the removal of the liquid following the drying. In order to obtain the ZSM-5 micro-porous material, silica sol, sodium aluminate, potassium hydrate, and distilled water were used, resulting in the preparatopn of the reactant gel having the composition of SiO₂:0.02Al₂O₃:0.25NaOH:60H₂O. Then, liquid containing the seed was added to the reactant gel so that 95% of the silica was obtained from the reactant gel and 5% of the silica was obtained from the seed on the basis of the silica. The mixture was maintained for fifteen minutes at 165° C. and 102 psi of the pressure similarly to embodiment 1. It was possible to know from the x-ray diffraction pattern of the product that ZSM-5 was obtained. Detailed condition of the experiment and property of the obtained material are summarized in table 1.

### Example 10 (SBA-16)

Reaction was performed similarly to example 1 to prepare the SBA-16 having mesopores and cubic structure. As for the raw materials, sodiummetasilicate nonahydrate (Na₂SiO₃9H₂O), chloric acid, tribloc copolymer (Pluronic F127; EO₁₀₆PO₇₀EO₁₀₆), and distilled water were used, and the composition of the reactants were SiO₂:3.2×10⁻⁴F127:7HCl:150H₂O. The reactant gel was stirred for thirty minutes to perform the aging, and apparatus similar to the reaction apparatus of the example 1 was used, and the temperature of the reactant gel was maintained at 100° C. for twenty-five minutes, and the pressure was maintained to be within 15 psi. It was possible to know from the x-ray diffraction pattern of the product that SBA-16 microporous material of the cubic structure was obtained, and detailed condition of the experiment and the property of the obtained material are summarized in table 1.

### Example 11 (BaTiO₃)

Reaction was performed similarly to example 1 to prepare the perovskite type inorganic material BaTiO₃, which is one of the mixed metal oxides. As for the reactants, titanium chloride, barium chloride, potassium hydrate, and distilled water were used, and the composition of the reactants was made to be TiCl₄:2.0BaCl₂:3.0KOH:300H₂O. The residence time in the respective reactor at 180° C. was maintained to be ten minutes. It was possible to know from the x-ray diffraction pattern of the product that perovskite type BaTiO₃ structure was obtained. Detailed condition of the experiment and the property of the obtained material are summarized in table 1.

TABLE 1
Conditions of the reaction and the result of
the reaction

| | Condition of reaction | | | | | |
|---|---|---|---|---|---|---|
| | | | | Residence | Result of | |
| | Composition of | Heating and | Temperature | time or | reaction | |
| Number of | the reactants | preparation | of reaction | reaction | Obtained | |
| embodiment | (mol ratio) | method^{b} | (° C.) | time(minute) | structure | S_{BET}^{c} |
| 1 | Al₂O₃:1.0P₂O₅:0.2SiO₂:1.5DPA:100H₂O | CMW | 180 | 5 | SAPO-11 | 300 |
| 2 | Al₂O₃:1.0P₂O₅:1.5DPA:100H₂O | CMW | 180 | 5 | AlPO-11 | 290 |
| Comparative | Al₂O₃:1.0P₂O₅:0.2SiO₂:1.5DPA:100H₂O | BMW | 180 | 5 | SAPO-11 | 300 |
| example 1 | | | | | | |
| Comparative | Al₂O₃:1.0P₂O₅:0.2SiO₂:1.5DPA:100H₂O | CE | 180 | 300 | SAPO-11 | 290 |
| example 2 | | | | | | |
| 3 | Al₂O₃:1.05P₂O₅:1.2TEA:100H₂O | CMW | 180 | 20 | AlPO-5 | 320 |
| 4 | Al₂O₃:1.0P₂O₅:0.1SiO₂:1.0HF:1.5DMPDA:100H₂O | CMW | 185 | 15 | SAPO-34 | 650 |
| 5 | NiCl₂:0.5P₂O₅:2.5NH₄F:100H₂O | CMW | 180 | 10 | VSB-1 | 180 |
| 6 | NiCl₂:0.5P₂O₅:0.233FeCl₂:2.5NH₄F:100H₂O | CMW | 180 | 10 | Fe-VSB-1 | 180 |
| 7 | NiCl₂:0.315P₂O₅:3NH₃:100H₂O | CMW | 180 | 3 | VSB-5 | 400 |
| Comparative | NiCl₂:0.315P₂O₅:3NH₃:100H₂O | BMW | 180 | 3 | VSB-5 | 390 |
| example 3 | | | | | | |
| 8 | NiCl₂:1.5GTA:1.0KOH:9.0IPA:30H₂O | CMW | 180 | 5 | MIL-77 | 270 |
| 9 | SiO₂:0.019Al₂O₃:0.2375NaOH:0.01TPAOH:58H₂O | CMW | 165 | 15 | ZSM-5 | 440 |
| 10 | SiO₂:3.2 × 10⁻⁴F127:7HCl:150H₂O | CMW | 100 | 25 | SBA-16 | 450 |
| 11 | TiCl₄:2.0BaCl₂:3.0KOH:300H₂O | CMW | 180 | 10 | BaTiO₃ | ND^{d} |

^{a}DPA: di-n-propyl amine; TEA: tri-ethyl amine; DMPDA: N,N-dimethyl-1,3-propanediamine; IPA: iso-propyl amine; GTA: glutaric acid
^{b}CE: conventional electric oven heating; CMW: continuous type microwave heating; BMW: batch type microwave heating.
^{c}BET surface area (m²/g); VSB-1, VSB-5, Fe-VSB-5 were measured after the dehydration in vacuum at 300° C., MIL-77was measured in vacuum at 200° C., the remainders were measured after the evacuating in vacuum at 300° C. following the calcining at 550° C.
^{d}ND; not measured

As described above, in the preparation of a material comprising porous material and mixed metal oxide, if the microwave energy is used as the heat source, the continuous stirred type reactor is used, the temperature of the slurry composed of the reactants, solvent, and the product is measured and controlled directly, and the pressure of the gas is measured and controlled to thereby progress the reaction, it is possible to prepare the porous materials and the mixed metal oxides continuously and stably at high temperature. Further, it is possible to reduce the production time, to increase the productivity, the reduce the energy consumption, to decrease the volume of the reactor, and the like so that it can be an advantageous synthesizing method in view of the economic property and environment. The porous materials can be applied to the catalyst, the catalytic support, the adsorbent, and applied to the storage of the gas, exchange of ions and nanometer reactor and the preparation of the nanometer materials. Also, BaTiO₃, which is one of the perovskite, can be used as the electro-ceramic materials such as the stacked ceramic condenser, and the like.

What is claimed is:

1. A method for continuously preparing porous materials and mixed metal oxides by using microwave energy as a heat source, and heating reactants to 50-250° C. in the presence of a solvent, the method comprising the steps of:
1) supplying the reactants to reactors having a sight glass to which the microwaves can be radiated; and
2) performing the reaction of the reactants by radiating the microwave through the sight glass; and
3) continuously draining the mixture of the product from the reactors.

2. The method for continuously preparing the porous materials and the mixed metal oxides according to claim 1, wherein the volume of the reactor is 200˜10000 cm³ per magnetron.

3. The method for continuously preparing the porous materials and the mixed metal oxides according to claim 1, wherein the reactors are connected in series to increase the residence time, or in parallel to enhance the productivity per time.

4. The method for continuously preparing the porous materials and the mixed metal oxides according to claim 1, wherein the porous material is any one selected from zeolite, aluminophosphate, silicoaluminophosphate, metalaluminophosphate, mesoporous material, and organic-inorganic hybrid.

5. The method for continuously preparing the porous materials and the mixed metal oxides according to claim 1, wherein the mixed metal oxide is BaTiO₃.

6. The method for continuously preparing the porous materials and the mixed metal oxides according to claim 1, wherein the product is prepared by adding a seed into the reactants or by aging the reactants below the temperature of reaction.

7. An apparatus for continuously preparing porous materials and mixed metal oxides by means of a continuously stirring reaction apparatus, by using microwave energy as a heat source, and heating reactants to 50˜250° C. in the presence of a solvent, the apparatus comprising:
a storage tank for storing the reactants;
continuous stirred type reactors having a sight glass for penetrating the microwaves for reacting the reactants supplied from the reactant storage tank with the microwaves;
microwave generator for continuously radiating the microwaves to the continuous stirred type reactors; and
a drain line on a side of the continuous stirred type reactor for draining the mixture of the product prepared from the continuous stirred type reactors.

8. The apparatus for continuously preparing porous materials and mixed metal oxides according to claim 7, further comprising a product storage tank for storing the product and a reactant storage tank for storing the reactants.

9. The apparatus for continuously preparing porous materials and mixed metal oxides according to claim 8, further comprising a cooler for cooling the gaseous material of the continuous stirred type reactor and the product in the drain line.

10. The apparatus for continuously preparing porous materials and mixed metal oxides according to claim 7, further comprising a temperature measuring and controlling unit for controlling the inside temperature of the continuous stirred type reactor and a pressure measuring and controlling unit for measuring the inside pressure of the reactor and controlling the pressure of the reactor.

11. The apparatus for continuously preparing porous materials and mixed metal oxides according to any one of claims 7 through 10, wherein at least two continuous stirred type reactors are connected to each other.
